(19) United States
(12) Patent Application Publication
(10) Pub. No.: US 2002/0115761 A1
(43) Pub. Date: Aug. 22, 2002

(54) Polycarbonate compositions

(76) Inventors: Thomas Eckel, Dormagen (DE); Andreas Seidel, Dormagen (DE); Bernd Keller, Geldern (DE); Dieter Wittmann, Leverkusen (DE)

Correspondence Address: BAYER CORPORATION, PATENT DEPARTMENT, 100 BAYER ROAD, PITTSBURGH, PA, 15205, US

(21) Appl. No.: 10/007,465

(22) Filed: Dec. 3, 2001

(30) Foreign Application Priority Data
Dec. 8, 2000 (DE) 10061080.3

(51) Int. Cl. C08K 5/51

(52) U.S. Cl. 524/136

(57) ABSTRACT

A flame resistant thermoplastic molding composition containing (A) polycarbonate and/or polyester carbonate and (B) a graft polymer impact strength-modifier is disclosed. The composition is characterized in that the ratio Z of the rubber containing portion Bₐ contained in component B to the rubber free portion K of vinyl(co)polymer in the composition is greater than “1”.

### FIELD OF THE INVENTION

The invention relates to impact strength-modified, flame resistant polycarbonate compositions with improved notch impact strength in the low temperature range.

### SUMMARY OF THE INVENTION

A flame resistant thermoplastic molding composition containing (A) polycarbonate and/or polyester carbonate and (B) a graft polymer impact strength-modifier is disclosed. The composition is characterized in that the ratio Z of the rubber containing portion Bₐ contained in component B to the rubber free portion K of vinyl(co)polymer in the composition is greater than 1.

### BACKGROUND OF THE INVENTION

Flame resistant polycarbonate/ABS molding compositions are known from numerous applications. EP-A 0 640 655 describes molding compositions of aromatic polycarbonate, styrene-containing copolymers and graft polymers, which may be rendered flame resistant with monomeric and/or oligomeric organic phosphorus compounds.

EP-A 0 363 608 discloses flame resistant polymer mixtures of aromatic polycarbonate, styrene-containing copolymer or graft copolymer, as well as oligomeric organic phosphates as flame retardants.

U.S. Pat. No. 5,061,745 describes polymer mixtures of aromatic polycarbonate, ABS graft polymer and/or styrene-containing copolymer and organic monophosphates as flame retardants.

In none of said documents are molding compositions with good low temperature strength described, which would be suitable for applications in the vehicle sector, such as motor vehicles or rolling stock, in aircraft construction, shipbuilding and other fields.

The use of flame resistant polycarbonate compositions for applications, for example in the vehicle sector, requires a combination of the properties of high mechanical strength, including in the low temperature range, and excellent flame resistance. In many cases said applications include safety-relevant parts that may be exposed to high impact stresses. The invention is therefore based on the object of preparing impact strength-modified and at the same time flame resistant polycarbonate compositions with improved mechanical properties in the low temperature range.

### DETAILED DESCRIPTION OF THE INVENTION

Said object is achieved by polycarbonate compositions containing impact strength-modified, flame resistant graft polymer with a notch impact strength of more than about 20 k/J m², preferably more than about 25 k/J m², measured to ISO 180 1A at 20° C.

It is advantageous that the requirements V-O according to UL 94 V Test at a thickness of the test bar of ≦3.2 mm, preferably ≦1.6 mm are met by the polycarbonate composition according to the invention. This means that a specimen of the polycarbonate compositions according to the invention may burn for not longer than 10 seconds after exposure to a test flame; the specimens do not show a total flame time of more than 50 seconds during the repeat exposure to flame of each sample set; they do not include any specimens that burn away completely up the holding clamp fixed to the upper end of the sample; they do not comprise any samples that ignite the cotton wool arranged beneath the sample due to burning drops or particles.

According to a preferred embodiment of the invention the desired properties are achieved with polycarbonate compositions which contain

(A) an aromatic polycarbonate and/or polyester carbonate,

B) an impact strength modifier,

C) optionally a thermoplastic homo- and/or copolymer and

D) a phosphorus compound,

wherein the ratio Z of the rubber-containing portion Bₐ contained in component B to the rubber-free portion K of the vinyl(co)polymer in the polycarbonate composition is greater than 1, preferably greater than 1.5, particularly preferably greater than 2 and in particular greater than 2.5.

The rubber-free portion K consists of the rubber-free portion of the vinyl(co)polymer in component B and the vinyl(co)polymer optionally added as component C).

According to a further preferred embodiment the polycarbonate composition according to the invention has a Vicat B 120 softening point of greater than about 100° C.

The compositions according to the invention contain preferably

(A) 40 to 99, preferably 60 to 98.5, in particular 60 to 95 parts by wt. of polycarbonate and/or polyester carbonate,

(B) 1 to 40, preferably 2 to 25, in particular 3 to 20 parts by wt. of impact strength modifier,

(C) 0 to 30, preferably 0 to 25 parts by wt. of homo- and/or copolymer and

(D) 0,5 to 30, preferably 1 to 25, in particular 2 to 18, especially 3.5 to 15 parts by wt. of phosphorus compound,

wherein the sum of the parts by weight is 100.

The suitable components according to the invention of the low-temperature impact resistant polycarbonate compositions rendered flame resistant are explained below from examples.

Component A

Suitable aromatic polycarbonates and/or aromatic polyester carbonates (Component A) according to the invention are known or preparable according to methods known in the literature (for the preparation of aromatic polycarbonates, see, for example, Schnell, “Chemistry and physics of polycarbonates”, Interscience Publishers, 1964, and DE-AS 1 495 626, DE-OS 2 232 877, DE-OS 2 703 376, DE-OS 2 714 544, DE-OS 3 000 610, DE-OS 3 832 396; for the preparation of aromatic polyester carbonates, e.g. DE-OS 3 077 934).

The preparation of aromatic polycarbonates may be carried out by reacting diphenols with carbonic acid halides, preferably phosgene, and/or with aromatic dicarboxylic acid halides, preferably benzene dicarboxylic halides, by the phase interface method, optionally with the use of chain terminators, for example monophenols, and optionally with the use of trifunctional or more than trifunctional branching agents, for example triphenols or tetraphenols.

Diphenols for preparing the aromatic polycarbonates and/or aromatic polyester polycarbonates are preferably of Formula (I)

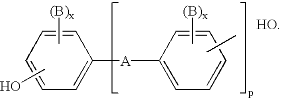

where

A represents a single bond, C₁ to C₅ alkylene, C₂ to C₅ alkylidene, C₅ to C₆ cycloalkylidene, —O—, —SO—, —CO—, —S—, —SO₂—, C₆ to C₁₂ arylene, to which further aromatic rings optionally containing hetero atoms may be condensed,

or a group of Formula (II) or (III)

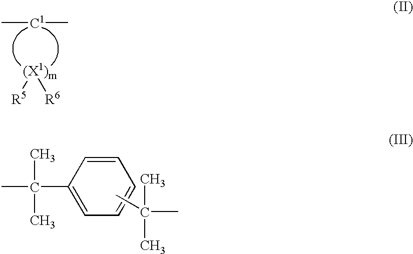

B represents respectively C₁ to C₁₂ alkyl, preferably methyl, halogen, preferably chlorine and/or bromine,

x are respectively independently of one another 0, 1 or 2 and

p is 1 or 0, and

R⁵ and R⁶ represent, selectably individually for each X¹ and independently of one another, hydrogen or C₁ to C₆ alkyl, preferably hydrogen, methyl or ethyl,

X¹ represents carbon and

m a whole number from 4 to 7, preferably 4 or 5, on condition that on at least one atom X¹, R⁵ and R⁶ are simultaneously alkyl.

Preferred diphenols are hydroquinone, resorcinol, dihydroxy diphenols, bis-(hydroxyphenyl)-C₁-C₅-alkanes, bis-(hydroxyphenyl)-C₅-C₆-cycloalkanes bis-(hydroxyphenyl)-ethers, bis-(hydroxyphenyl)-sulfoxides, bis-(hydroxyphenyl)-ketones, bis-(hydroxyphenyl)-sulfones and α,α-bis-hydroxyphenyl-diisopropyl-benzenes, as well as their derivatives brominated in the ring and/or chlorinated in the ring.

Particularly preferred diphenols are 4,4′-dihydroxydiphenyl, bisphenol-A, 2,4-bis(4-hydroxyphenyl)-2-methylbutane, 1,1-bis-(4-hydroxyphenyl)-cyclohexane, 1,1-bis-(4-hydroxyphenyl)-3, 3,5-trimethylcyclohexane, 4,4′-dihydroxydiphenyl sulfide, 4,4′-dihydroxydiphenyl-sulfone as well as their di- and tetrabrominated or chlorinated derivatives such as 2,2-bis(3-chloro-4-hydroxyphenyl)-propane, 2,2-bis-3,5-dichloro4-hydroxyphenyl)-propane or 2,2-bis-(3,5-dibromo4-hydroxyphenyl)-propane. Preferred in particular is 2,2-bis-(4-hydroxyphenyl)-propane (bisphenol-A). The diphenols may be used individually or as any mixtures. The diphenols are known in the literature or obtainable by methods known in the literature.

Suitable chain terminators for the preparation of the thermoplastic, aromatic polycarbonates are, for example, phenol, p-chlorophenol, p-tert.-butylphenol or 2,4,6-tribromophenol, but also long-chain alkyl phenols, such as 4-(1,3-tetramethylbutyl)-phenol according to DE-OS 2 842 005 or monoalkyl phenyl or dialkyl phenols having a total of 8 to 20 C. atoms in the alkyl substituents, such as 3,5-di-tert.-butyl phenol, p-iso-octyl phenol, p-tert.-octyl phenol, p-dodecyl phenol and 2-(3,5-dimethylheptyl)-phenol and 4-(3,5-dimethylheptyl)-phenol. The amount of chain terminators to be used amounts in general to between 0.5 mol. % and 10 mol. %, referred to the molar sum of the respective diphenols used.

The thermoplastic, aromatic polycarbonates have mean weight-average molecular weights (Mw, measured for example by means of ultracentrifuge or by light-scattering measurement) of 10 000 to 200 000, preferably 15 000 to 80 000.

The thermoplastic, aromatic polycarbonates may be branched in known manner, namely preferably by the incorporation of 0.05 to 2.0 mol. %, referred to the sum of the diphenols used, of trifunctional or more than trifunctional compounds, for example those having three and more phenolic groups.

Both homopolycarbonates and copolycarbonates are suitable. To prepare copoly-carbonates according to the invention according to component A, 1 to 25 wt. %, preferably 2.5 to 25 wt. %, referred to the total amount of diphenols to be used, of polydiorganosiloxanes having hydroxyaryloxy terminal groups may also be used. The lafter are known, for example, from U.S. Pat. No. 3,419,634 and preparable by methods known in the literature. The preparation of copolycarbonates containing polydiorganosiloxane is described in DE-OS 33 34 782.

Preferred polycarbonates are, in addition to the bisphenol-A homopolycarbonates, the copolycarbonates of bisphenol-A having up to 15 mol. %, referred to the molar sums of diphenols, of other diphenols mentioned as preferred or particularly preferred, in particular 2,2-bis(3,5-dibromo-4-hydroxylphenyl)-propane.

Aromatic dicarboxylic acid dihalides for preparing aromatic polyester carbonates are preferably the di-acid dichlorides of isophthalic acid, terephthalic acid, diphenylether-4,4′-dicarboxylic acid and naphthalene-2,6-dicarboxylic acid.

Particularly preferred are mixtures of the di-acid dichlorides of isophthalic acid and terephthalic acid in the ratio between 1:20 and 20:1.

In the preparation of polyestercarbonates a carbonic acid halide, preferably phosgene, is additionally used at the same time as a bifunctional acid derivative.

There are considered as chain terminators for the preparation of the aromatic polyester carbonates, in addition to the monophenols already mentioned, also their chloroformates, as well as the acid chlorides of aromatic monocarboxylic acids, which may optionally be substituted by C₁ to C₂₂ alkyl groups or by halogen atoms, as well as aliphatic C₂ to C₂₂ monocarboxylic acid chlorides.

The amount of chain terminators amounts to respectively 0.1 to 10 mol. %, referred in the case of the phenolic chain terminators to moles of diphenols and in the case of monocarboxylic acid chloride chain terminators to moles of dicarboxylic acid chlorides.

The aromatic polyester carbonates may also contain incorporated hydroxycarboxylic acids. They may be both linear and, in known manner, branched (DE-OS 2 940 024 and DE-OS 3 007 934).

There may be used as branching agents, for example, 3- or multifunctional carboxylic acid chlorides, such as trimesic acid trichloride, cyanuric acid trichloride, 3,3′-4,4′-benzophenone-tetracarboxylic acid tetrachloride, 1,4,5,8-naphthalenetetracarboxylic acid tetrachloride or pyromellitic acid tetrachloride, in amounts of 0.01 to 1.0 mol. % (referred to dicarboxylic acid dichlorides used) or 3- or multifunctional phenols, such as phloroglucinol, 4,6-dimethyl-2,4,6-tri-(4-hydroxyphenyl)-heptene-2,4,4-dimethyl-2,4-6 tri-(4-hydroxyphenyl)-heptane, 1,3,5-tri-(4-hydroxyphenyl)-benzene, 1,1,1-tri-(4-hydroxyphenyl)-ethane tri-(4-hydroxyphenyl)-phenylmethane, 2,2-bis[4,4-bis(4-hydroxyphenyl)-cyclohexyl]-propane, 2,4-bis(4-hydroxyphenylisopropyl)-phenol, tetra-4-hydroxyphenyl)-methane, 2,6-bis(2-hydroxy-5-methyl-benzyl)4-methyl-phenol, 2-(4-hydroxyphenyl)-2-(2,4-dihydroxyphenyl)-propane, tetra-(4-[4-hydroxyphenyl-isopropyl]-phenoxy)-methane, 1,4-bis[4,4′-dihydroxytriphenyl)-methyl]-benzene, in amounts of 0.01 to 1.0 mol. % referred to diphenols used. Phenolic branching agents may be set out with the diphenols, acid chloride branching agents may be introduced together with the acid dichlorides.

The proportion of carbonate structure units in the thermoplastic, aromatic polyester carbonate may be varied at will. Preferably the proportion of carbonate groups amounts to up to 100 mol. %, in particular up to 80 mol. %, particularly preferably up to 50 mol. %, referred to the sum of ester groups and carbonate groups. Both the ester portion and the carbonate portion of the aromatic polyester carbonates may be present in the form of blocks or distributed randomly in the polycondensate.

The relative solution viscosity (ηᵣₑₗ) of the aromatic polycarbonates and polyester carbonates lies in the range 1.18 to 1.4, preferably 1.20 to 1.32 (measured on solutions of 0.5 g polycarbonate or polyester carbonate in 100 ml methylene chloride solution at 25° C.).

The thermoplastic, aromatic polycarbonates and polyester carbonates may be used alone or in any mixture. They may be contained in the composition in an amount of 40 to 99, preferably 60 to 98.5, parts by weight.

Component B

Component B comprises one or more graft polymers of

B. 1 5 to 95, preferably 30 to 90 wt. %, of at least one vinyl monomer,

B.2 95 to 5, preferably 70 to 10 wt. %, of one or more graft bases with glass transition temperatures <10° C., preferably <0° C., particularly preferably <−20° C.

The graft base B.2 has in general a mean particle size (d₅₀ value) of 0.05 to 10 μm, preferably 0.1 to 5 μm, particularly preferably 0.2 to 1 μm.

Monomers B.1 are preferably mixtures of

B.1.1 50 to 99 parts of aromatic vinyls and/or aromatic vinyls substituted in the ring (such as styrene, α-methyl styrene, p-methyl styrene, p-chlorostyrene) and/or methacrylic acid-C₁-C₈)-alkylates, such as methyl methacrylate, ethyl methacrylate), and

B.1.2 1 to 50 parts by wt. of vinyl cyanides (unsaturated nitriles such as acrylonitrile and methacrylonitrile) and/or (meth)acrylic acid-C₁-C₈-alkylates, such as methyl methacrylate, n-butyl acrylate, t-butyl acrylate, and/or derivatives (such as anhydrides and imides) of unsaturated carboxylic acids, for example maleic anhydride and N-phenyl-maleinimide.

Preferred monomers B.1.1 are selected from at least one of the monomers styrene, α-methyl styrene and methyl methacrylate, preferred monomers B.1.2 are selected from at least one of the monomers acrylonitrile, maleic anhydride and methyl methacrylate. Particularly preferred monomers are B.1.1 styrene and B.1.2 acrylonitrile.

Graft bases B.2 suitable for the graft polymers B are, for example, diene rubbers, EP(D)M rubbers, i.e. those based on ethylene/propylene and optionally diene, acrylic, polyurethane, silicone, chloroprene and ethylene/vinyl acetate rubbers.

Preferred as graft polymers B.2 are diene rubbers, for example based on butadiene and isoprene, or mixtures of diene rubbers or copolymers of diene rubbers, or their mixtures with further copolymerisable monomers (e.g. according to B.1.1 and B.1.2), on condition that the glass transition temperature of the B.2 components lies below <10° C., preferably <0° C., particularly preferably <−10° C. Pure polybutadiene rubber is particularly preferred.

Particularly preferred polymers B are, for example, ABS polymers (emulsion, bulk and suspension ABS), such as are described e.g. in DE-OS 2 035 390 (=U.S. Pat. No. 3,644,574) or in DE-OS 2 248 242 (=GB-PS 1 409 275) or in Ullmanns Enzyklopädie der Technischen Chemie, Vol. 19 (1980), p. 280 ff. The gel portion of the graft base B.2 amounts to at least 30 wt. %, preferably at least 40 wt. % (measured in toluene).

The graft copolymers B are prepared by radical polymerization, e.g. by emulsion, suspension, solution or bulk polymerization, preferably by emulsion or bulk polymerization.

Also particularly suitable as graft rubbers are ABS polymers which are prepared by redox initiation with an initiator system of organic hydroperoxide and ascorbic acid according to U.S. Pat. No. 4,937,285.

Since, as is known, the graft monomers are not necessarily fully grafted onto the graft base during the grafting reaction, according to the invention there are understood by graft polymers B also products that are obtained by (co-) polymerization of the graft monomers in the presence of the graft base and that accumulate at the same time during the working-up.

The rubber-containing portion Bₐ (defined in parts by weight) of component B for the determination of ratio Z is the non-soluble constituent of the graft polymer. The rubber-free portion K results from the vinyl(co)polymer (B_{b}) which is obtained in the graft polymerization and which is soluble and the vinyl(co)polymer (C), which can be additionally added to the mixture as component C). The rubber-free portion K of the copolymer is thus the sum of the quantities B_{b} and C (in parts by weight). The ration Z is Bₐ/K.

The rubber-free portion of the graft polymer is determined by extracting the soluble portion with the aid of a suitable solvent such as for example methylene chloride, acetone, methyl ethyl ketone, dimethylformamide, dimethyl acetate or mixtures of 2 or more of these solvents. After processing in a generally known manner, e.g. by precipitation, the soluble portion of the graft polymer is obtained. The portion of insoluble rubber containing constituents can then be calculated therefrom.

Suitable acrylic rubbers according to B.2 of the polymers B are preferably polymers from alkyl acrylates, optionally with up to 40 wt. %, referred to B.2, of other polymerizable, ethylenically unsaturated monomers. The preferred polymerizable alkyl acrylates include C₁ to C8 alkylates, for example methyl, ethyl, butyl, n-octyl and 2-ethylhexylates; halogen-alkylates, preferably halogen-C₁-C₈-alkylates, such as chloroethyl acrylate and mixtures of said monomers.

For crosslinking, monomers may be copolymerized with more than one polymerizable double bond. Preferred as examples of crosslinking monomers are esters of unsaturated monocarboxylic acid having 3 to 8 C atoms and of unsaturated monobasic alcohols having 3 to 12 C atoms, or of saturated polyols having 2 to 4 OH groups and 2 to 20 C atoms, such as ethyleneglycol dimethacrylate, allyl methacrylate; polyunsaturated heterocyclic compounds, such as trivinyl and triallyl cyanurate; polyfunctional vinyl compounds, such as di- and trivinylbenzenes; but also triallyl phosphate and diallyl phthalate. Preferred crosslinking monomers are allyl methacrylate, ethyleneglycol dimethacrylate, diallyl phthalate and heterocyclic compounds which comprise at least three ethylenically unsaturated groups. Particularly preferred crosslinking monomers are the cyclic monomers triallyl cyanurate, triallyl isocyanurate, triacryloylhexahydro-s-triazine, triallyl benzenes. The amount of the crosslinking monomers amounts preferably to 0.02 to 5, in particular 0.05 to 2 wt. %, referred to the graft base B.2. In the case of cyclic crosslinking monomers having at least three ethylenically unsaturated groups it is advantageous to limit the amount to less than 1 wt. % of the graft base B.2.

Preferred “other” polymerizable, ethylenically unsaturated monomers that may be used together with the acrylates optionally for preparing the graft base B.2 are e.g. acrylonitrile, styrene, a-methyl styrene, acrylic amides, vinyl-C₁-C₆-alkyl ethers, methyl methacrylate, butadiene. Preferred acrylic rubbers as graft base B.2. are emulsion polymers that have a gel content of at least 60 wt. %.

Further suitable graft bases according to B.2 are silicone rubbers with graft-active sites, such as are described in DE-OS 3 704 657, DE-OS 3 704 655, DE-OS 3 631 540 and DE-OS 3 631 539.

The gel content of the graft base B.2 is determined at 25° C. in a suitable solvent (M. Hoffmann, H. Kromer, R. Kuhn, Polymeranalytik I und II, Georg Thieme-Verlag, Stuttgart 1977).

The mean particle size d₅₀ is the diameter above and below which 50 wt. % of the particles lie in each case. It may be determined by means of ultracentrifugal measurement (W. Scholtan, H. Lange, Kolloid, Z. und Z. Polymere 250 (1972), 782-1796).

The graft polymers may be used in the composition according to the invention in an amount of 0.5 to 60, preferably 1 to 40 and in most preferred manner 2 to 25 parts by wt. Mixtures of different graft polymers may also be present.

Component C

Component C comprises one or more thermoplastic vinyl(co)polymers C.1 and/or polyalkylene terepthalates C.2.

Suitable as vinyl(co) polymers C.1 are polymers of at least one monomer from the group of the aromatic vinyls, vinyl cyanides (unsaturated nitriles), (meth)acrylic acid-(C₁-C₈)-alkylates, unsaturated carboxylic acids and derivatives (such as anhydrides and imides) of unsaturated carboxylic acids. Suitable in particular are (co) polymers of

C.1.1 50 to 99, preferably 60 to 80 wt. % of aromatic vinyls and/or aromatic vinyls substituted in the ring such as styrene, α-methyl styrene, p-methyl styrene, p-chlorostyrene) and/or methacrylic acid-(C₁-C₈)-alkylates, such as methyl methacrylate, ethyl methacrylate), and

C.1.2 1 to 50, preferably 20 to 40 wt. % of vinyl cyanides (unsaturated nitriles) such as acrylonitrile and methacrylonitrile and/or (meth)acrylic acid-(C₁-C₈)-alkylates, such as methyl methacrylate, n-butyl acrylate, t-butyl acrylate, and/or unsaturated carboxylic acids, such as maleic acid, and/or derivatives, such as anhydrides and imides, of unsaturated carboxylic acids, for example maleic anhydride and N-phenylmaleinimide).

The (co)polymers C.1 are resin-like, thermoplastic and rubber-free. The copolymer from C.1.1 styrene and C.1.2 acrylonitrile is particularly preferred.

The (co) polymers according to C.1 are known and may be prepared by radical polymerization, in particular by emulsion, suspension, solution or bulk polymerization. The (co)polymers possess preferably mean molecular weights Mw (weight-average, determined by light scattering or sedimentation) of between 15 000 and 200 000.

The polyalkylene terephthalates of component C.2 are reaction products from aromatic dicarboxylic acids or their reactive derivatives, such as dimethyl esters or anhydrides, and aliphatic, cycloaliphatic or araliphatic diols, as well as mixtures of said reaction products.

Preferred polyalkylene terephthalates contain at least 80 wt. %, preferably at least 90 wt. %, referred to the dicarboxylic acid component, of terephthalic acid residues and at least 80 wt. %, preferably at least 90 mol. %, referred to the diol component, of ethyleneglycol- and/or butane diol-1,4 residues.

The preferred polyalkylene terephthalates may in addition to terephthalic acid esters contain up to 20 mol. %, preferably up to 10 mol. %, of residues of other aromatic or cycloaliphatic dicarboxylic acids having 8 to 14 C atoms or of aliphatic dicarboxylic acids having 4 to 12 C atoms, for example residues of phthalic acid, isophthalic acid, naphthalene-2,6-dicarboxylic acid, 4,4′-diphenyidicarboxylic acid, succinic acid, adipic acid, sebacic acid, azelaic acid, cyclohexanediacetic acid.

The preferred polyalkylene terephthalates may in addition to ethyleneglycol or butanediol-1,4 residues contain up to 20 mol. %, preferably up to 10 mol. %, of other aliphatic diols having 3 to 12 C atoms or cycloaliphatic diols having 6 to 21 C atoms, e.g. residues of propane diol-1,3,2-ethylpropanediol-1,3,neopentylglycol, pentanediol-1,5, hexanediol-1,6, cyclohexane-dimethanol-1,4,3-ethylpentanediol-2,4,2-methylpentanediol-2,4,2,2,4-trimethylpentanediol-1,3,2-ethylhexanediol-1,3,2,2-diethylpropanediol-1,3,hexanediol-2,5,1,4-di-(β-hydroxyethoxy)-benzene, 2,2-bis-(4-hydroxycyclohexyl)-propane, 2,4-dihydroxy-1,1,3,3-tetramethyl-cyclobutane, 2,2-bis-(4-β-hydroxyethoxy-phenyl)-propane and 2,2-bis-(4-hydroxypropoxyphenyl)-propane (DE-A 2 407 674, 2 407 776, 2 715 932).

The polyalkylene terephthalates may be branched by the incorporation of relatively small amounts of tri- or tetravalent alcohols or tri- or tetrabasic carboxylic acids, e.g. according to DE-A 1 900 270 and U.S. Pat. No. 3,692,744. Examples of preferred branching agents are trimesic acid, trimelletic acid, trimethylolethane and -propane and pentaerythritol.

Particularly preferred are polyalkylene terephthalates which have been prepared solely from terephthalic acid and its reactive derivatives (e.g. its dialkylates) and ethyleneglycol and/or butanediol-1,4, and mixtures of said polyalkylene terephthalates.

Mixtures of polyalkylene terephthalates contain 1 to 50 wt. %, preferably 1 to 30 wt. %, of polyethylene terephthalate and 50 to 99 wt. %, preferably 70 to 99 wt. %, of polybutylene terephthalate.

The preferably used polyalkylene terephthalates possess in general an intrinsic viscosity of 0.4 to 1.5 dl/g, preferably 0.5 to 1.2 dl/g, measured in phenol/o-dichlorobenzene (1:1 parts by wt.) at 25° C. in the Ubbelohde viscosimeter.

The polyalkylene terephthalates may be prepared by known methods (see e.g. Kunststoff-Handbuch, Vol. Vil, p. 695 ff., Carl-Hanser-Verlag, Munich 1973).

The vinyl(co)polymers or polyalkylene terephthalates may be contained in the composition according to the invention in amounts of 0 to 45, preferably 1 to 30 and particularly preferably 2 to 25 parts by weight.

Component D

Phosphorus-containing flame retardants (D) in the sense according to the invention are preferably selected from the groups of mono- and oligomeric phosphorus and phosphonic acid esters, phosphonate amines and phosphazenes, wherein mixtures of several components selected from one or various of said groups may also be used as flame retardants. Other halogen-free phosphorus compounds not specifically mentioned here may also be used either alone or in any combination with other halogen-free phosphorus compounds.

Preferred mono- and oligomeric phosphorus or phosphonic acid esters are phosphorus compounds with the general formula (IV)

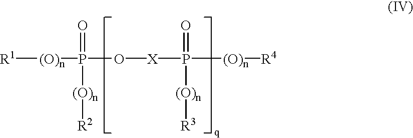

where

R¹, R², R³ and R⁴ signify respectively independently of one another optionally halogenated C₁ to C₈-alkyl, C₅ to C₆-ycloalkyl optionally substituted by alkyl, preferably C₁ to C₄-alkyl, and/or halogen, preferably chlorine, bromine, C₆ to C₂₀-aryl or C₇ to C₁₂-aralkyl,

n signifies, independently of one another, 0 or 1,

q 1 to 30and X a mono- or polynuclear aromatic residue with 6 to 30 C atoms, or a linear or branched aliphatic residue with 2 to 30 C atoms, which may be OH-substituted and contain up to 8 ether bonds.

Preferably R¹, R², R³ and R⁴ stand independently of one another for C₁ to C₄ alkyl, phenyl, naphthyl or phenyl-C₁-C₄-alkyl. The aromatic groups R¹, R², R³ and R⁴ may for their part be substituted with halogen and/or alkyl groups, preferably chlorine, bromine and/or C₁ to C₄-alkyl. Particularly preferred aryl residues are cresyl, phenyl, xylenyl, propylphenyl or butylphenyl, as well as the corresponding brominated and chlorinated derivatives therefrom.

X in Formula (IV) signifies preferably a mono- or polynuclear aromatic residue with 6 to 30 C atoms. The latter is preferably derived from diphenols of Formula (I).

n in Formula (IV) may, independently of one another, be 0 or 1, preferably n is equal to 1.

q stands for values from 0 to 30. If mixtures of various components of Formula (IV) are used, mixtures [having] preferably number-averaged q values of 0.3 to 20, particularly preferably 0.5 to 10, in particular 0.5 to 6, may be used.

X stands particularly preferably for

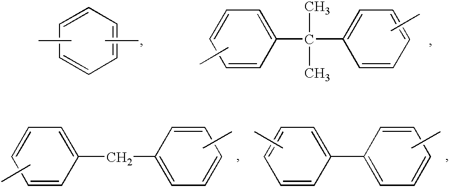

or their chlorinated or brominated derivatives, in particular X is derived from resorcinol, hydroquinone, bisphenol A or diphenylphenol. Particularly preferably X is derived from bisphenol A.

The use of oligomeric phosphates of Formula (IV) that are derived from bisphenol A is particularly advantageous, since the compositions equipped with said phosphorus compound exhibit a particularly high stress cracking and hydrolysis resistance, as well as a particularly low proneness to plate-out during processing by injection molding. In addition, a particularly high heat resistance may be achieved with said flame retardants.

There may be used as component C according to the invention monophosphates (q=0), oligophosphates (q=1-30) or mixtures of mono- and oligophosphates.

Monophosphorus compounds of Formula (IV) are in particular tributyl phosphate, tris-(2-chloroethyl)-phosphate, tris-(2,3-dibromoprobyl)-phosphate, triphenyl phosphate, tricresyl phosphate, diphenylcresyl phosphate, diphenyloctyl phosphate, diphenyl-2-ethylcresyl phosphate, tri-(isopropylphenyl)-phosphate, halogen-substituted aryl phosphates, methyl phosphonic acid dimethyl esters, methyl phosphinous acid diphenyl esters, phenyl phosphonic acid diethyl esters, triphenyl phosphine oxide or tricresyl phosphine oxide.

The phosphorus compounds according to component C. Formula (IV) are known (cf. e.g. EP-A 363 608, EP-A 640 655), or may be prepared by known methods in a similar manner (e.g. Ullmanns Enzyklopädie der technischen Chemie, Vol.18, p. 301 ff. 1979; Houben-Weyl, Methoden der organischen Chemie, Vol. 12/1, p. 43: Beilstein Vol. 6, p.177).

The mean q values may be determined by the composition of the phosphate mixture (molecular weight distribution) being determined by means of a suitable method (Gas Chromatography (GC), High Pressure Liquid Chromatography (HPLC), Gel Permeation Chromatography) (GPC)) and the mean values for q being calculated from the lafter.

Phosphonate amines are preferably compounds of Formula (V)

A_{3-y}—NB¹_{y} (V)

in which

A stands for a group of Formula (Va)

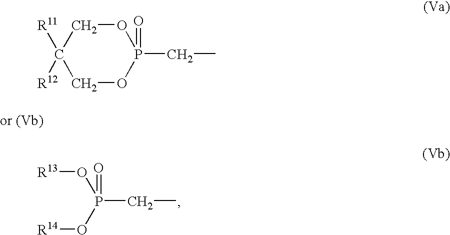

R¹¹ and R¹² stand independently of one another for unsubstituted or substituted C₁-C₁₀-alkyl or for unsubstituted or substituted C₆ to C₁₀-aryl,

R¹³ and R¹⁴ stand independently of one another for unsubstituted or substituted C₁-C₁₀-alkyl or unsubstituted or substituted C₆ to C₁₀-aryl or

R¹³ and R¹⁴ stand together for unsubstituted or substituted C₃ to C-₁₀-alkylene,

y signifies the numerical values 0, 1 or 2 and

B¹ stands independently for hydrogen, optionally halogenated C₂ to C₈-alkyl, unsubstituted or substituted C₆- to C₁₀-aryl.

B¹ stands preferably independently for hydrogen, for ethyl, n- or iso-propyl, which may be substituted by halogen, unsubstituted C₆ to C₁₀-aryl or C₆ to C₁₀-aryl substituted by C₁ to C₄-alkyl and/or halogen, in particular phenyl or naphthyl.

Alkyl in R¹¹, R¹², R¹³ and R¹⁴ stands independently preferably for methyl, ethyl, n-propyl, iso-propyl, n-, iso-, sec. or tert.-butyl, pentyl or hexyl.

Substituted alkyl in R¹¹, R¹², R¹³ and R¹⁴ stands independently preferably for C₁- to C₁₀-alkyl substituted by halogen, in particular for mono- or disubstituted methyl, ethyl, n-propyl, iso-propyl, n-, iso-, sec. or tert.-butyl, pentyl or hexyl.

C₆ to C₁₀-aryl stands in R¹¹, R¹², R¹³ and R¹⁴ independently preferably for phenyl, naphthyl or binaphthyl, in particular o-phenyl, o-naphthyl, o-binaphthyl, which may be substituted (in general mono-, di- or trisubstituted) by halogen.

R¹³ and R¹⁴may form a ring structure together with the oxygen atoms to which they are directly bonded and the phosphorus atom.

Mentioned by way of example and as preferred are: 5,5,5′,5′,5,5,-hexamethyltris(1,3,2-dioxaphosphorinan-methane)amino-2,2′,2,,-trioxide of Formula (Va-1)

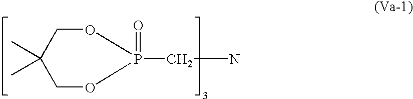

1,3,2-dioxaphosphorinan-2-methanamine, N-butyl-N[(5,5-dimethyl-1,3,2-dioxa-phosphorinan-2-yl)methyl]-5,5-dimethyl, P,2-dioxide; 1,3,2-dioxaphosphorinan-2-methanamine, N-[[5,5-dimethyl-1,3,2-dioxaphosphorinan-2-yl)methyl]-5,5-dimethyl-N-phenyl-,P,2-dioxide; 1,3,2-dioxaphosphorinan-2-methanamine, N, N-dibutyl-5,5-dimethyl-,2-oxide, 1,3,2-dioxaphosphorinan-2-methanamine, N-[(5,5-dimethyl-1,3,2-dioxaphosphorinan-2-yl)methyl]-N-ethyl-5,5-dimethyl-,P,2-dioxide, 1,3,2-dioxa-phosphorinan-2-methanamine, N-butyl-N-[(5,5-dichloromethyl-1,3,2-dioxaphosphorinan-2-yl)-methyl]-5,5-di-chloromethyl-,P,2-dioxide, 1,3,2-dioxaphosphorinan-2-methan-amine, N-[5,5-di-chloromethyl-1,3,2-dioxaphosphorinan-2-yl)methyl]-5,5-di-chloromethyl-N-phenyl-, P,2-dioxide; 1, 3,2-dioxaphosphorinan-2-methanamine, N, N-di-(4-chlorobutyl)-5,5-dimethyl-2-oxides; 1,3,2-dioxaphosphorinan-2-methan-imine, N-[(5,5-dimethyl-1,3,2-dioxaphosphorinan-2-yl) methane]-N-(2-chloroethyl)-5, 5-di(choro-methyl)-,P2-dioxide.

Also preferred are:

Compounds of Formula (Va-2) or (Va-3)

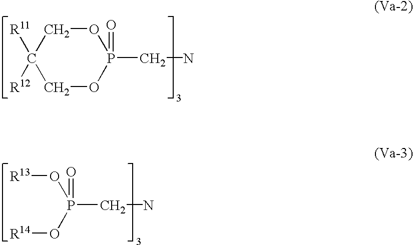

where

R¹¹, R¹², R¹³ and R¹⁴ have the meanings given above.

Particularly preferred are compounds of Formula (Va-2) and (Va-1). The preparation of the phosphonate amines is described for example in U.S. Pat. No. 5,844,028.

Phosphazenes are compounds of Formulas (VIa) and (VIb)

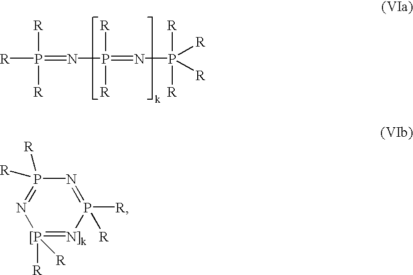

where

R is the same or different, and stands for amino, C₁- to C₈-alkyl optionally halogenated in each case, preferably halogenated with fluorine, or C₁- to C₈-alkoxy, C₅- to C₆-cycloalkyl optionally substituted in each case by alkyl, preferably C₁- to C₄-alkyl, and/or halogen, preferably chlorine and/or bromine, C₆- to C₂₀-aryl, preferably phenyl or naphthyl, C₆ to C₂₀-aryloxy, preferably phenoxy, naphthyloxy, or C₇ to C₁₂-aralkyl, preferably phenyl-C₁-C₄-alkyl.

k stands for 0 or a number from 1 to 15, preferably for a number from 1 to 10.

Propoxyphosphazene, phenoxyphosphazene, methylphenoxyphosphazene, amino-phosphazene and fluoroalkylphosphazene may be mentioned by way of example. Phenoxyphosphazene is preferred.

The phosphazenes may be used alone or as a mixture. The group R may be always the same or 2 or more groups in Formulas (Ia) and (Ib) may be different. Phosphazenes and their preparation are described for example in EP-A 728 811, DE-A 1 961 668 and WO 97/40092.

The flame retardants may be used alone or in any mixture with one another or in a mixture with other flame retardants. The flame retardant containing phosphorus may be used in an amount of 0.1 to 30, preferably 1 to 25 and most preferably 2 to 20 parts by weight in the composition according to the invention.

Component E

The flame retardants according to component D are often used in combination with so-called anti-dripping agents, which reduce the tendency of the material to drip off while burning in the event of a fire. Compounds of the substance classes of the fluorinated polyolefins, the silicones and aramide fibres may be mentioned here by way of example. The latter may also be utilized in the compositions according to the invention. Fluorinated polyolefins are preferably used as anti-dripping agents. The fluorinated polyolefins are in general contained in the mixture in an amount of 0.01 to 3, preferably 0.05 to 1.5 parts by wt.

Fluorinated polyolefins are known and described for example in EP-A 0 640 655. They are marketed by DuPont under the trade-name Teflon®, for example Teflon® 30N.

The fluorinated polyolefins may be used both in pure form and in the form of a coagulated mixture of emulsions of the fluorinated polyolefins with emulsions of the graft polymers (component B) or with an emulsion of a copolymer, preferably on styrene/acrylonitrile base, wherein the fluorinated polyolefin is mixed as an emulsion with an emulsion of the graft polymer or the copolymer and then coagulated.

In addition, the fluorinated polyolefins may be used as a pre-compound with the graft polymer (component B) or a copolymer, preferably on styrene/acrylonitrile base. The fluorinated polyolefins are mixed as a powder with a powder or granules of the graft polymer or copolymer and compounded in the melt in general at temperatures of 200 to 330° C. in conventional units such as internal mixers, extruders or double-shafted screw conveyors.

The fluorinated polyolefins may also be used in the form of a master batch, which is prepared by emulsion polymerization of at least one monoethylenically unsaturated monomer in the presence of an aqueous dispersion of the fluorinated polyolefin. Preferred monomer components are styrene, acrylonitrile and their mixtures. The polymer is used as a free-flowing powder after acid precipitation and subsequent drying.

The coagulates, pre-compounds or master batches possess conventionally solid contents of fluorinated polyolefin of 5 to 95 wt. %, preferably 7 to 60 wt. %.

Component F

Component F comprises extremely finely divided inorganic powders which may be added only up to an amount such that the claimed notch impact strength is retained.

Suitable extremely finely divided inorganic powders F consist preferably of at least one polar compound of one or more metals of the 1st to 5th main group (groups 1, 2, 13, 14, 15 of the Periodic Table according to IUPAC) or the 1st to 8th subgroup (groups 3 to 12 of the Periodic Table according to IUPAC) of the Periodic Table, preferably of the 2nd to 5th main group (groups 2, 13 to 15 of the Periodic Table according to IUPAC) or 4th to 8th subgroup (group 4 to 10 of the Periodic Table according to IUPAC), particularly preferably of the 3rd to 5th main group (groups 13 to 15 of the Periodic Table according to IUPAC) or 4th to 8th subgroup (group 4 to 10 of the Periodic Table according to IUPAC), or of compounds of said metals with at least one element selected from oxygen, hydrogen, sulfur, phosphorus, boron, carbon, nitrogen or silicon.

Preferred compounds are, for example, oxides, hydroxides, water-containing oxides, sulfates, sulfites, sulfides, carbonates, carbides, nitrates, nitrites, borates, silicates, phosphates, hydrides, phosphites or phosphonates.

Preferably the extremely finely divided inorganic powders consist of oxides, phosphates, hydroxides, preferably of TiO₂, SiO₂, SnO₂, ZnO, ZnS, boehmite, ZrO₂, Al₂O₃, aluminum phosphates, iron oxides, also TiN, WC, AIO(OH), SB₂O₃ iron oxides, NaSO₄, vanadium oxides, zinc borate, silicates such as Al-silicates, Mg-silicates, one-, two-, three-dimensional silicates. Mixtures and doped compounds are also usable.

In addition, said nano-scale particles may be surface-modified with organic molecules, in order to obtain a better compatibility with the polymers. Hydrophobic or hydrophilic surfaces may be produced in this way.

Hydrate-containing aluminum oxides, e.g. boehmite or TiO₂, are particularly preferred.

The mean particle diameters of the nano particles are less then equal to 200nm, preferably less then equal to 150 nm, in particular 1 to 100 nm.

Particle size and particle diameter signifies always the mean particle diameter d₅₀, determined by ultracentrifuge measurements after W. Scholtan et al., Kolloid-Z. and Z. Polymere 250 (1972), pp. 782-796.

The inorganic powder is worked into the thermoplastic molding composition in amounts of 0.5 to 40, preferably 1 to 25, particularly preferably from 2 to 15 wt. %, referred to the thermoplastic material.

The inorganic compounds may be present as powders, pastes, sols, dispersions or suspensions. Powders may be obtained from dispersions, sols or suspensions by precipitation.

The powders may be worked into the thermoplastic molding compositions by conventional methods, for example by direct kneading or extruding of molding compositions and the extremely finely divided inorganic powders. Preferred methods are represented by the preparation of a master batch, e.g. in flame retardant additives, and at least one component of the molding compositions according to the invention in monomers or solvents, or the co-precipitation of a thermoplastic component and the extremely finely divided inorganic powders, e.g. by co-precipitation of an aqueous emulsion and the extremely finely divided inorganic powders, optionally in the form of dispersions, suspensions, pastes or sols of the extremely finely divided inorganic materials.

Further Components

The molding compositions according to the invention may contain at least one of the conventional additives, such as lubricants and mould release agents, for example pentaerythritol tetrastearate, nucleating agents, anti-static agents, stabilizers, fillers and reinforcing agents different from component F), as well as dyes and pigments.

Preferred as reinforcing agents are glass fibres. Preferred as fillers that may also have a reinforcing effect are glass beads, mica, silicates, quartz and talc.

The molding compositions according to the invention may contain up to 35 wt. %, referred to the total molding composition, of a further, optionally synergically acting flame retardant. There are mentioned as further flame retardants, by way of example, organic halogen compounds such as decabromobisphenyl ether, tetrabromobisphenol, inorganic halogen compounds such as ammonium bromide, nitrogen compounds such as melamine, melamine-formaldehyde resins, inorganic hydroxide compounds such as Mg-, Al-hydroxide, inorganic compounds such as antimony oxides, barium metaborate, hydroxoantimonate, zirconium oxide, zirconium hydroxide, molybdenum oxide, ammonium molybdate, zinc borate, ammonium borate, barium metaborate, talc, silicate, silicon oxide and tin oxide, as well as siloxane compounds.

The fillers and reinforcing agents, as well as additional flame retardants, may be used only in amounts of the molding composition according to the invention such that the latter does not drop below the required notch impact strength value.

The compositions according to the invention are prepared by mixing the respective components in known manner and melt-compounding and melt-extruding them at temperatures of 200° C. to 300° C. in conventional units such as internal mixers, extruders and double-shafted screw conveyors.

The mixing of the individual components may take place in known manner both successively and simultaneously, namely both at about 20° C. (room temperature) and at higher temperature.

The thermoplastic molding compositions according to the invention are because of their outstanding flame resistance, in particular the short burning time, and because of their good mechanical properties in the low-temperature range and their high heat resistance, suitable for the production of moldings of any kind, in particular those with increased requirements as to mechanical properties in the low temperature range, for example in the vehicle sector. Because of the heat resistance and Theological properties, processing temperatures of >240° C. are preferred.

The molding compositions according to the invention may be used for producing moldings of any kind. In particular, moldings may be produced by injection molding. As well as for vehicle applications, the compositions are also suitable for the following applications: domestic appliances, monitors, printers, copiers or covering slabs for the building sector and parts for rolling stock. They are in addition utilizable in the field of electronics, because they have very good electrical properties, internal components for rolling stock, ships, busses, other motor vehicles and aircraft, hub caps, cases of electrical devices containing miniature transformers, cases for devices for data dissemination and transmission, flush-mounted wall elements, cases for safety equipment, thermally insulated transport containers, equipment for accommodating or delivering small animals, cover grates for fan openings, moldings for summer-houses and tool-sheds, cases for garden tools.

A further form of processing is the production of moldings by deep drawing out of previously produced slabs or sheets.

A further subject of the present invention is therefore also the use of the molding compositions according to the invention for producing moldings of any kind, preferably those mentioned above, as well as the moldings from the molding compositions according to the invention.

The following examples serve for further explanation of the invention.

### EXAMPLES

In accordance with the figures in Table 1, five polycarbonate compositions were produced, processed into test specimens and tested.

Component A1

Linear polycarbonate based on bisphenol A with a relative solution viscosity of 1.272, measured in CH₂Cl₂ as solvent at 25° C. and a concentration of 0.5 g/100 ml.

Component A2

Branched polycarbonate based on bisphenol A with a relative solution viscosity of 1.34, measured in methylene chloride as solvent at 25° C. and a concentration of 0.5 g/ml.

Component B

Graft polymer consisting of 40 parts by wt. of a copolymer from styrene and acrylonitrile in the ratio of 72:28 on 60 parts by wt. of crosslinked polybutadiene rubber in particulate form (mean particle diameter d₅₀=0.32 μm), prepared by emulsion polymerization. By means of extraction in methyl ethyl ketone, subsequent precipitation and drying the rubber-containing portion Bₐ is determined to be 80 wt. % and the rubber-free portion B_{b} to be 20 wt. % (based on B).

Component C

Styrene/acrylonitrile copolymer with a styrene/acrylonitrile ratio by weight of 72:28 and an intrinsic viscosity of 0.55 dl/g (measurement in dimethyl formamide at 20° C.).

Component D1

Triphenyl phosphate, Disflamoll TP® from Bayer AG.

Component D2

m-phenylene-bis (di-phenylphosphate), Fyrolflex® from AKZO Nobel Chemicals GmbH.

Component D3

Bisphenol-A-based oligophosphate, Reofos BAPP from Great Lakes Chem.

Preparation and Testing of the Molding Compositions According to the Invention

The mixing of the components of the compositions takes place on a 3 1 internal mixer. The moldings are produced on an injection molding machine, Arburg 270 E type, at 260° C.

The determination of the notch impact strength ak is carried out to ISO 180/1 A. The determination of the Vicat B softening point takes place to DIN 53 460 (ISO 306) on rods 80×10×4 mm³ in size. The fire behavior of the samples was measured to UL-Subj. 94 V on rods 127×12.7×1.6 mm in size produced on an injection molding machine at 260° C.

TABLE 1

| Composition [wt. %] | 1 | 2 | 3 | 4 | 5 |
|---|---|---|---|---|---|
| A1 | 69.8 | 83.1 | 69.1 | 70.0 | — |
| A2 | | | | | 81.4 |
| B | 12.0 | 7.5 | 13.0 | 10.7 | 8.2 |
| of which Bₐ | 9.6 | 6.0 | 10.4 | 8.6 | 6.6 |
| B_{b} | 2.4 | 1.5 | 2.6 | 1.9 | 1.2 |
| C | 6.1 | 2.0 | 6.3 | 5.5 | — |
| D1 | 11.3 | 6.6 | — | — | — |
| D2 | — | — | 10.8 | — | — |
| D3 | — | — | — | 13.0 | 10.0 |
| PTFE | 0.4 | 0.4 | 0.4 | 0.4 | 0.2 |
| Mould release agent | 0.4 | 0.4 | 0.4 | 0.4 | 0.2 |
| $Ratio Z = \frac{{B}_{a}}{{B}_{b} + C}$ | 1.13 | 1.71 | 1.17 | 1.13 | 4.13 |
| aₖ − 20° C. [kJ/m²] | 24 | 25 | 27 | 25 | 38 |
| Vicat B120 [° C.] | 90 | 109 | 95 | 102 | 114 |
| UL94 V with 1.5 mm | V-0 | V-0 | V-0 | V-0 | V-0 |

The results given in the bottom part of the table show that all the samples exhibit the desired notch impact strength at −20° C. of greater than 20 kg/M² and a good to very good heat resistance, and possess the required flame resistance.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A flame resistant thermoplastic molding composition containing A) polycarbonate and/or polyester carbonate and B) a graft polymer impact strength modifier, wherein the ratio Z of the rubber containing portion Bₐ contained in component B to the rubber free portion K of vinyl(co)polymer in the composition is greater than 1.

2. A flame resistant thermoplastic molding composition containing (A) a polymeric resin selected from at least one of polycarbonate and polyester-carbonate and (B) a graft polymer impact strength-modifier, the composition having a notch impact strength of more than 20 kJ/m², determined in accordance with ISO 180 1A at −20° C.

3. The composition of claim 1 characterized in that its flame resistance is V-0 according to UL 94 V at a thickness of the test bar of ≦3.2 mm.

4. The composition of claim 2 wherein polymeric resin is at least one member selected from the group consisting of aromatic polycarbonate and aromatic polyester carbonate.

5. The composition of claim 1 comprising
A) 40 to 99 parts by weight of polycarbonate and/or polyestercarbonate,
B) 1 to 40 parts by weight of impact strength modifier,
C) 0 to 30 parts by weight of vinyl(co)polymer and/or polyalkyleneterepthalate and
D) 0.5 to 30 parts by weight of phosphorous compound wherein the sum of the parts by weight of all components in the composition is 100.

6. The composition of claim 1 in which the graft polymer (B) is composed of
B.1) 5 to 95 wt. % of one or more vinyl monomers grafted on
B.2) 95 to 5 wt. % of one or more graft bases with a glass transition temperature of <10° C.

7. The composition of claim 5 in which the graft polymer is present in an amount of 2 to 25 parts by wt.

8. The composition of claim 1 comprising a phosphorus compound in an amount of 1 to 25 parts by wt.

9. The composition of claim 1 in which the vinyl(co)polymer (C) is composed of 50 to 99 wt. % of at least one of styrene, a-methyl styrene, p-methyl styrene, p-chlorostyrene and methacrylic acid(C₁-C₈)-alkylates and 1 to 50 wt. % of at least one of vinyl cyanides, (meth)arcylic acid-(C₁-C₈)-alkylate, unsaturated carboxylic acids and derivatives of unsaturated carboxylic acids.

10. The composition of claim 6 in which monomers B.1 are mixture of 50 to 99 wt. % of at least one of styrene, α-methyl styrene, p-methyl styrene, p-chlorostyrene and methacrylic acid(C₁-C₈)-alkylates and 1 to 50 wt. % of at least one of vinyl cyanides, (meth)acrylic acid-(C₁-C₈)-alkylate, unsaturated carboxylic acids and derivatives of unsaturated carboxylic acid.

11. The composition of claim 6 in which the graft base B.2 is selected from at least one of diene rubbers, EP(D)M rubbers, acrylate rubbers, silicone rubbers, chloroprene rubbers, styrene/butadiene copolymers and styrene/isoprene copolymers.

12. The composition of claim 5 wherein the rubber free portion K consists of the rubber free portion of the vinyl(co)polymer in component B) and the vinyl(co)polymer which may be added as component C).

13. A molded article comprising the composition of claim 1.
